(19) United States
(12) Patent Application Publication
(10) Pub. No.: US 2019/0094931 A1
(43) Pub. Date: Mar. 28, 2019

(54) ENERGY HARVESTING and AMBIENT CONDITION TRACKING in IoT for ADAPTIVE SENSING and SELF-MODIFYING APPLICATIONS

(71) Applicant: INTEL CORPORATION, Santa Clara, CA (US)

(72) Inventors: Khondker Z. Ahmed, Hillsboro, OR (US); Vivek K. De, Beaverton, OR (US); Nachiket V. Desai, Portland, OR (US); Suhwan Kim, Portland, OR (US); Harish K. Krishnamurthy, Beaverton, OR (US); Xiaosen Liu, Portland, OR (US); Turbo Majumder, Portland, OR (US); Krishnan Ravichandran, Saratoga, CA (US); Christopher Schaef, Hillsboro, OR (US); Vaibhav Vaidya, Portland, OR (US); Sriram R. Vangal, Portland, OR (US)

(73) Assignee: INTEL CORPORATION, Santa Clara, CA (US)

(21) Appl. No.: 15/718,991

(22) Filed: Sep. 28, 2017

(51) Int. Cl. G06F 1/26; G06N 99/00

(52) U.S. Cl. CPC G06F 1/26; G06N 99/005

(57) ABSTRACT

Various embodiments of the invention may analyze previous patterns of harvested energy to predict future patterns of available harvested energy. This prediction may then be used to choose from among multiple methods of energy reduction techniques. The energy reduction techniques may include multiple versions of reducing or modifying instruction execution. Reduced instruction execution may include reducing the precision of various calculations.

### TECHNICAL FIELD OF THE INVENTION

Various embodiments of the invention relate to controlling power consumed by digital integrated circuits with an intention of achieving minimal consumption of harvested power under various conditions.

### BACKGROUND

The Internet of Things (IoT) has greatly increased interest in, and the use of, harvested energy sources, since IoT devices are frequently in places where an ongoing electric supply is unavailable, and even periodically replacing batteries is problematic. But harvested energy is generally irregular, and may rely on such sources as solar, wind, RF, piezoelectric, and others. Such harvested energy may come in bursts, and the energy received during those bursts may not be sufficient to perform the desired functions, leaving those functions incomplete before power is lost. In many IoT applications, this is not an acceptable situation.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a block diagram of an energy management system, according to an embodiment of the invention.

FIG. 2 shows a more detailed block diagram of an energy management system, according to an embodiment of the invention.

FIG. 3 shows a flow diagram of a method of energy management, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. The instructions may be read and executed by one or more processors to enable performance of the operations described herein. The medium may be internal or external to the device containing the processor(s), and may be internal or external to the device performing the operations. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In a system that relies on harvested energy that arrives in a non-continuous manner, various embodiments of the invention may monitor incoming energy over a window of time, and use that information to learn power supply patterns. These patterns may include the timing of incoming energy (both duration of input and cycle time between inputs), and accumulated energy received during those times. It may then predict an energy budget for the device. This prediction may then be used to select an operational technique that may allow the device to perform desired tasks with reduced power consumption suitable for that energy budget. Within this document, the term ‘operational techniques’ may refer to different ways to accomplish one or more tasks, each technique consuming a different amount of energy.

For example, if a first and second operational technique accomplished the same end result, but the second consumed less energy, the second might be chosen when a smaller energy budget is available. Since the energy budget may be a prediction rather than a certainty, sometimes the supply of harvested energy may end before the task has been completed. To deal with such circumstances, some embodiments may store a small amount of energy (e.g., in capacitors) to allow the device to shut down in an orderly fashion after it stops receiving the harvested energy. In some embodiments, shutting down in an orderly fashion may include storing the data that has been calculated thus far, and/or checkpointing the instruction stream so that it may be resumed when harvested power is again available.

Predicting the amount of energy to be harvested may include analyzing patterns of harvesting from previous experience. Various learning algorithms may be used for this purpose. The result of the prediction about harvested energy may result in an energy budget for the upcoming tasks. This learning/prediction may occur before the system goes into operation, and/or may occur from time to time during the system's operation, and/or may be an ongoing activity during the system's operation. The approach to learning/prediction may depend on the amount of expected consistency and predictability in the energy supply.

Predicting the energy that will be consumed with a particular operational technique may include learning from past patterns of energy consumption, or may be pre-determined through testing and stored in a table. In some embodiments, predicted harvesting and/or predicted operational techniques may be adjusted during the execution of a particular task, based on changing status. When determining the anticipated expenditure of energy, it should be noted that 1) the calculations used in that determination may themselves consume energy, and 2) the sensors that are being monitored may themselves consume energy. Any determination of consumed energy should include these factors.

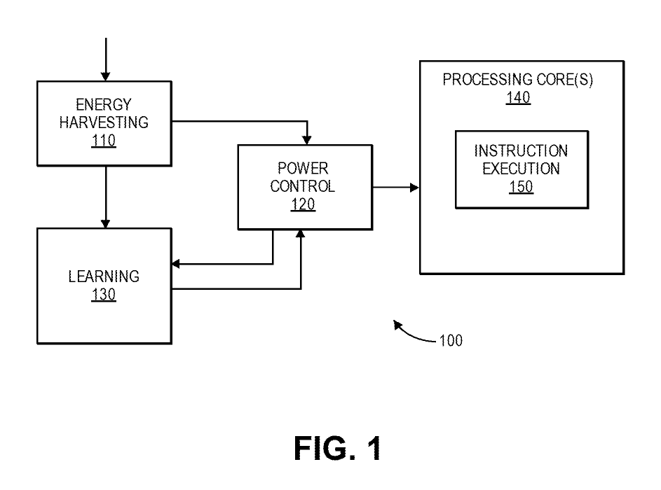

FIG. 1 shows a block diagram of an energy management system, according to an embodiment of the invention. In system 100, an energy harvesting module 110 may be used to collect harvested energy. Harvested energy may consist of various types, such as but not limited to solar energy, wind energy, electromagnetic energy, piezoelectric energy, etc. The energy harvesting function may also include other elements external to the energy harvesting module 110, such as solar panels for solar energy, wind turbines for wind energy, and others.

Power Control module 120 may be coupled to the energy harvesting module, and may be used to receive the harvested energy and distribute it as needed. Learning module 130 may receive inputs from the energy harvesting module 110 so that it can analyze patterns of incoming harvested energy and make predictions of future incoming harvested energy based on those patterns. The Learning module may also receive input from the Power Control module related to how the power is being used, and what methods the system is performing to reduce energy consumption. The Learning module may also send outputs to the Power Control module to direct the Power Control module on how to control the various power modes, based on the analysis performed by the Learning module.

One or more Processing Cores 140 may be coupled to the Power Control module to perform the various functions of the system. These functions are not discussed here as they are application-dependent and might cover a wide range of functionality. In some embodiments, these processing cores may provide for the capability of self-modifying instruction code. Each different version of code may perform a slightly different version of the same functionality, with each version consuming a different amount of energy. Some embodiments may have multiple instruction streams pre-coded, and may select the one with a reduced energy consumption.

For instance, some calculations require an iterative series of calculations. As an example, if the pre-fetched instructions carry out the function sin(x) via its truncated McLaurin series expansion sin(x)=x−x³/3!+x⁵/5!−x⁷/7!, using fixed point number representation with 16 bits, the controller may take several approaches to reducing the energy expended, assuming an answer with lower accuracy is acceptable:

a) reduce the number of bits of precision of x in the instruction code from 16 to a smaller number;

b) concatenating instruction execution by eliminating one or more of the higher order terms in the series expansion;

c) perform both a) and b);

d) retrieve needed sin(x) value from a pre-calculated lookup table;

e) halt the execution unit and don't determine sin(x) at this time.

Depending on the type and source of the harvested energy, the energy received may vary from one harvesting session to the next. One harvesting session may provide enough energy for relatively high-precision calculations, while the next may not. In such situations, the device may calculate results with relatively high precision when there is sufficient energy for that option, and store the results for subsequent lookup when there is not sufficient energy.

In some embodiments, user inputs may affect the techniques used.

The user inputs may accomplish various things, such as but not limited to: 1) determine which functions will or will not be performed, 2) determine criticality and/or priority of various functions, 3) determine which approach may be used to accomplish a function, 4) set threshold values for harvested energy that will be used to determine how much accumulated energy is anticipated before processing will begin, 5) etc.

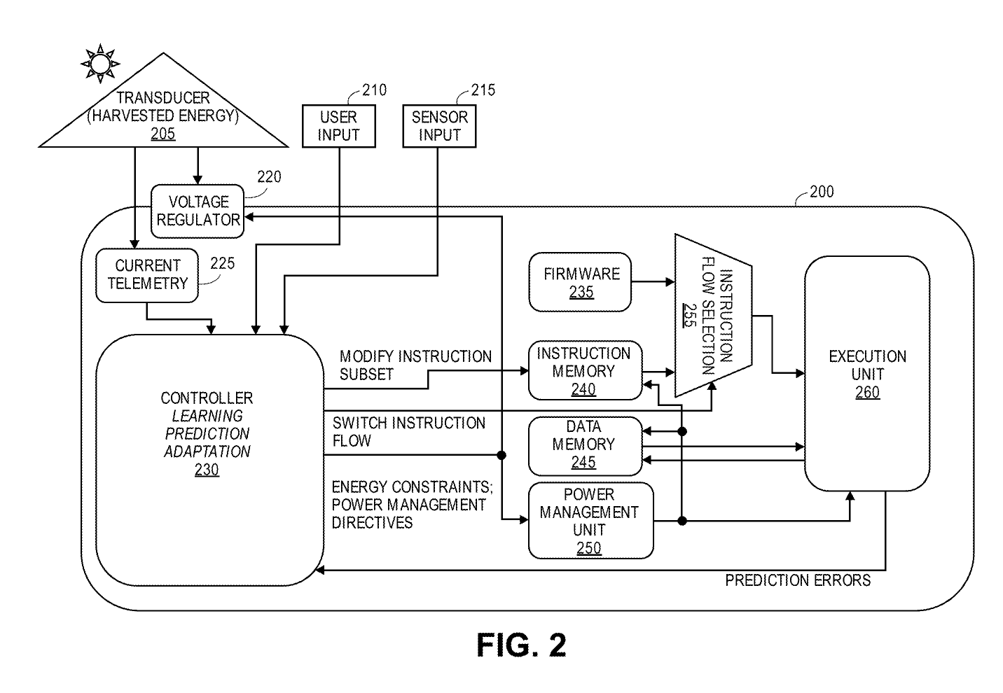

FIG. 2 shows a more detailed block diagram of an energy management system, according to an embodiment of the invention. In FIG. 2, transducer 205 may convert harvested energy to electrical energy. Some embodiments may also include a user input device 210 to allow a user to provide input signals or commands. Sensor input 215 may provide information on various environmental conditions. In some embodiments, using these sensors may be the primary reason for this system to exist, as the sensors may be placed in a remote location for ongoing monitoring. In some embodiments, module 200 may be a single module or even be in a single integrated circuit, while transducer 205 and/or user input 210 and/or sensor input 215 may be considered external devices and may be provided by different vendors.

Examining the operation of module 200 more closely, input energy from transducer 205 may provide input voltage to voltage regulator 220. A reading of the current from the transducer 205 via connect telemetry unit 225, user input 210, and sensor input 215 may also be fed to controller 230. Based on these three inputs, Controller 230 may perform various functions integral to the operation of the system. These functions may be grouped broadly into ‘learning’, ‘prediction’, and ‘adaptation’.

‘Learning’ may be broadly defined as gaining useful information from these inputs over time to analyze patterns of behavior. ‘Prediction’ may be broadly defined as using the learned patterns of behavior to predict future patterns of behavior, primarily how much harvested energy will be received and when it will be received, and converting this into an energy budget. ‘Adaptation’ may be broadly defined as modifying the operation to enable successful completion under the predicted energy budget. ‘Adaptation’ may also include modifying Prediction algorithms when it is determined that the existing algorithms are frequently insufficient to make accurate predictions.

Power management unit 250 may control voltage and frequency settings to various parts of the system, thus using these two known techniques of reducing power consumption. This may be done when the Controller 230 sends power management directives to the Power management unit 250, which in turn may send control signals to the Voltage regulator 220.

Two types of memory are shown in the illustrated embodiment, memory 245 for data and memory 240 for instructions. Other embodiments may combine instructions and data into the same memory. Instructions may also be contained in Firmware 235. Instruction flow selection logic 255 may be used to obtain instructions from different sources, such as firmware 235 or instruction memory 240, under the control of Controller 230. Regardless of where the instructions are sourced from, the selected instructions may be passed on to the Execution unit 260. This process allows the controller to change which instruction stream is executed, based on reducing energy consumption. Another technique for changing the instructions that are modified is for the Controller to modify the instruction subsets that are in the Instruction Memory 240.

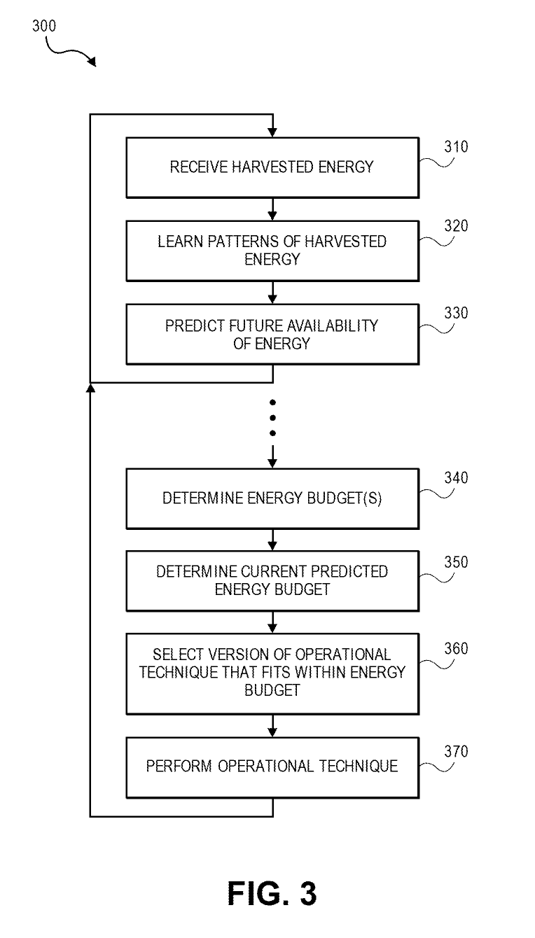

FIG. 3 shows a flow diagram of a method of energy management, according to an embodiment of the invention. In flow diagram 300, at 310 the device may receive harvested energy in a manner that is intermittent in time and/or amount. Based on this reception, the device may learn patterns of harvested energy at 320, and make predictions of future receptions of the availability of harvested energy at 330. As indicated, blocks 310, 320, and 330 may be repeated on an ongoing basis.

When sufficient cycles of harvested energy have been received, the Prediction logic may determine one or more energy budgets at 340. Multiple energy budgets might be desirable if the incoming energy is variable, but variable in a predictable way. Thus, at 350 it may be determined what the current energy budget is predicted to be. At 360, an operational technique may be selected for that energy budget. The selected operational technique may then be performed at 370. When the task is complete, the flow diagram may return to 310 to receive subsequent inputs of harvested energy.

### Examples

The following examples pertain to particular embodiments:

Example 1 includes a power management device, comprising an energy harvesting module to receive harvested energy, a power control module coupled to the energy harvesting module, an instruction execution module coupled to the power control module, and a learning module coupled to the power control module to predict future patterns of energy availability, wherein the device is configured to: receive harvested energy through the energy harvesting module, predict future patterns of available harvested energy, and adjust energy consumption by the instruction execution module based on the predicted future patterns of available energy.

Example 2 includes the power management device of example 1, wherein the learning module is to predict the future patterns of available harvested energy availability based on previous patterns of available harvested energy.

Example 3 includes the power management device of example 1, wherein the instruction execution module is to have multiple modes of operation, each mode with a different level of energy consumption.

Example 4 includes the power management device of example 3, wherein at least one of the multiple modes of operation comprises modifying one or more existing instructions.

Example 5 includes the power management device of example 3, wherein a first of the multiple modes of operation is to rely on a truncated series of instructions to reduce energy consumption.

Example 6 includes the power management device of example 3, wherein a first of the multiple modes of operation is to reduce a number of bits of precision to reduce energy consumption.

Example 7 includes the power management device of example 3, wherein a first of the multiple modes of operation is to avoid performance of one or more functions to reduce energy consumption.

Example 8 includes the power management device of example 1, wherein the learning module is to include energy expended in the learning module when determining energy predictions.

Example 9 includes a method of managing power, comprising: receiving harvested energy in a non-continuous manner, learning patterns of the received harvested energy, predicting availability of the harvested energy based on the patterns; and determining an energy budget based on the predicted availability.

Example 10 includes the method of example 9, further comprising: selecting an operational technique that fits within the energy budget, and executing the operational technique.

Example 11 includes the method of example 10, wherein said selecting the operational technique comprises modifying one or more existing instructions.

Example 12 includes the method of example 10, wherein said selecting the operational technique comprises selecting a different instruction set.

Example 13 includes the method of example 10, wherein said selecting the operational technique comprises reducing iterations in an iterative calculation.

Example 14 includes the method of example 9, further comprising checkpointing instruction execution before the harvested energy stops being available.

Example 15 includes a computer-readable non-transitory storage medium that contains instructions, which when executed by one or more processors result in performing operations comprising: receiving harvested energy in a non-continuous manner, learning patterns of the received harvested energy, predicting availability of the harvested energy based on the patterns; and determining an energy budget based on the predicted availability.

Example 16 includes the medium of example 15, wherein the operations further comprise: selecting an operational technique that fits within the energy budget, and executing the operational technique.

Example 17 includes the medium of example 16, wherein said selecting the operational technique comprises modifying one or more existing instructions.

Example 18 includes the medium of example 16, wherein said selecting the operational technique comprises selecting a different instruction set.

Example 19 includes the medium of example 16, wherein said selecting the operational technique comprises reducing iterations in an iterative calculation.

Example 20 includes the medium of example 15, wherein the operations further comprise checkpointing instruction execution before the harvested energy stops being available.

Example 21 includes a power management device, comprising means to: receive harvested energy, predict future patterns of available harvested energy, and adjust energy consumption based on the predicted future patterns of available energy.

Example 22 includes the power management device of example 21, wherein the means to predict the future patterns of available harvested energy comprises means to base the prediction on previous patterns of available harvested energy.

Example 23 includes the power management device of example 21, further comprising means for multiple modes of operation, each mode with a different level of energy consumption.

Example 24 includes the power management device of example 23, wherein the means for multiple modes of operation comprises means for modifying one or more existing instructions.

Example 25 includes the power management device of example 23, wherein at least one of the multiple modes of operation is to comprise means to truncate a series of instructions to reduce energy consumption.

Example 26 includes the power management device of example 23, wherein at least one of the multiple modes of operation is to comprise means to reduce a number of bits of precision to reduce energy consumption.

Example 27 includes the power management device of example 23, wherein at least one of the multiple modes of operation is to comprise means to avoid performance of one or more functions to reduce energy consumption.

The foregoing description is intended to be illustrative and not limiting. Variations will occur to those of skill in the art. Those variations are intended to be included in the various embodiments of the invention, which are limited only by the scope of the following claims.

What is claimed is:

1. A power management device, comprising:
an energy harvesting module to receive harvested energy;
a power control module coupled to the energy harvesting module;
an instruction execution module coupled to the power control module;
a learning module coupled to the power control module to predict future patterns of energy availability;
wherein the device is configured to:
receive harvested energy through the energy harvesting module;
predict future patterns of available harvested energy; and
adjust energy consumption by the instruction execution module based on the predicted future patterns of available energy.

2. The power management device of claim 1, wherein the learning module is to predict the future patterns of available harvested energy availability based on previous patterns of available harvested energy.

3. The power management device of claim 1, wherein the instruction execution module is to have multiple modes of operation, each mode with a different level of energy consumption.

4. The power management device of claim 3, wherein at least one of the multiple modes of operation comprises modifying one or more existing instructions.

5. The power management device of claim 3, wherein a first of the multiple modes of operation is to rely on a truncated series of instructions to reduce energy consumption.

6. The power management device of claim 3, wherein a first of the multiple modes of operation is to reduce a number of bits of precision to reduce energy consumption.

7. The power management device of claim 3, wherein a first of the multiple modes of operation is to avoid performance of one or more functions to reduce energy consumption.

8. The power management device of claim 1, wherein the learning module is to include energy expended in the learning module when determining energy predictions.

9. A method of managing power, comprising:
receiving harvested energy in a non-continuous manner;
learning patterns of the received harvested energy;
predicting availability of the harvested energy based on the patterns; and
determining an energy budget based on the predicted availability.

10. The method of claim 9, further comprising:
a. selecting an operational technique that fits within the energy budget; and
b. executing the operational technique.

11. The method of claim 10, wherein said selecting the operational technique comprises modifying one or more existing instructions.

12. The method of claim 10, wherein said selecting the operational technique comprises selecting a different instruction set.

13. The method of claim 10, wherein said selecting the operational technique comprises reducing iterations in an iterative calculation.

14. The method of claim 9, further comprising checkpointing instruction execution before the harvested energy stops being available.

15. A computer-readable non-transitory storage medium that contains instructions, which when executed by one or more processors result in performing operations comprising:
receiving harvested energy in a non-continuous manner;
learning patterns of the received harvested energy;
predicting availability of the harvested energy based on the patterns; and
determining an energy budget based on the predicted availability.

16. The medium of claim 15, wherein the operations further comprise:
a. selecting an operational technique that fits within the energy budget; and
b. executing the operational technique.

17. The medium of claim 16, wherein said selecting the operational technique comprises modifying one or more existing instructions.

18. The medium of claim 16, wherein said selecting the operational technique comprises selecting a different instruction set.

19. The medium of claim 16, wherein said selecting the operational technique comprises reducing iterations in an iterative calculation.

20. The medium of claim 15, wherein the operations further comprise checkpointing instruction execution before the harvested energy stops being available.
